(19) United States
(12) Patent Application Publication
(10) Pub. No.: US 2010/0168344 A1
(43) Pub. Date: Jul. 1, 2010

(54) POLYESTER BASED BLEND AND PACKAGING ARTICLE MADE THEREFROM

(75) Inventors: Roy Wu, Taoyuan Hsien (TW); Pang-Chin Liu, Taoyuan Hsien (TW); Shu-Chen Lee, Taoyuan Hsien (TW); Hsiang-Chin Tsai, Taoyuan Hsien (TW)

Correspondence Address: FOLEY HOAG, LLP;PATENT GROUP, WORLD TRADE CENTER WEST, 155 SEAPORT BLVD, BOSTON, MA, 02110, US

(73) Assignee: Far Eastern New Century Corporation, Taipei City (TW)

(21) Appl. No.: 12/648,781

(22) Filed: Dec. 29, 2009

(30) Foreign Application Priority Data
Dec. 31, 2008 (TW) 097151666

(51) Int. Cl. C08L 67/03

(52) U.S. Cl. 525/418

(57) ABSTRACT

A polyester based blend includes: a polyester to be formed into a polymer matrix for a packaging article when the polyester based blend is melted and extruded; an oxidative catalyst to be dispersed in the polymer matrix; and an additive of an aldehyde that is to be dispersed in the polymer matrix, that is catalytically reactive with oxygen at room temperature in the presence of the oxidative catalyst, and that has a melting point greater than room temperature. A packaging article made from the melt-extruded polyester based blend is also disclosed.

### CROSS-REFERENCE TO RELATED APPLICATION

This application claims priority of Taiwanese Application No. 097151666, filed on Dec. 31, 2008.

### BACKGROUND OF THE INVENTION

1. Field of the Invention

This invention relates to a polyester based blend and a packaging article more particularly to a polyester based blend capable of scavenging oxygen and useful for making a packaging article and to a packaging article made therefrom.

2. Description of the Related Art

Polymer materials have advantages, such as lightweight, production on a large scale, reasonable cost, and easy recycling, and thus are widely used in the production of packaging articles. Among polymer materials, polyester (e.g., polyethylene terephthalate (PET)) is frequently used as a main component of polymer materials.

However, when a packaging article made from polyesters is used for packaging oxygen-sensitive foods or beverages, such as juices, vegetables, flavorings, etc., a trace amount of oxygen will permeate through the packaging article to influence taste of contents (i.e., foods and beverages) inside the packaging article. To solve the above problem, the oxygen barrier property of the packaging article should be improved. Methods for improving the oxygen barrier property of the packaging article can be divided into two different types: (1) a passive barrier technology and (2) an active oxygen scavenge technology. The principle of the passive barrier technology is to provide a stereo hindrance for packaging articles by virtue of a specific molecular structure or molecular arrangement of a chemical material. However, the packaging article formed through the passive barrier technology is likely to encounter a problem that oxygen will permeate through the packaging article when the packaging article is used for a long period of time. As a consequence, the active oxygen scavenge technology has become more attractive recently. In this technology, the polyester for making the packaging articles is modified or an oxygen scavenger is blended into the polyester so as to reduce the amount of oxygen inside the packaging articles and 50 as to prevent permeation of oxygen through the packaging articles.

Conventional oxygen scavengers include, for example, iron powder, MXD6, a mixture of ascorbic acid and a metallic chloride, and a mixture of MXD6 and a transitional metal. U.S. Pat. Nos. 6,083,585 and 6,863,988 also disclose an oxygen scavenging composition comprising a polyester copolymer. The copolymer was prepared by polymerizing polyester and the olefin oligomer, and comprises the polyester-based segments and the olefin oligomer segments which provide the oxygen scavenging function. The olefin oligomer was selected from the group consisting of polypropylene, poly(4-methyl)-1-pentene, unhydrogenated polybutadiene, and combinations thereof.

Although the aforesaid materials exhibit oxygen scavenging ability, they have some disadvantages, e.g., high-cost, inferior transparency of packaging articles attributed to incompatibility, and recycling problem etc.

Therefore, there is a need in the art to provide a polymer material capable of scavenging oxygen, preventing permeation of oxygen through a packaging article, and useful for making packaging articles.

### SUMMARY OF THE INVENTION

Therefore, an object of the present invention is to provide a polyester based blend that is capable of scavenging oxygen and that can overcome at least one of the aforesaid drawbacks of the prior art.

According to one aspect of this invention, there is provided a polyester based blend capable of scavenging oxygen and useful for making a packaging article. The polyester based blend comprises: (1) a polyester to be formed into a polymer matrix for the packaging article when the polyester based blend is melted and extruded; (2) an oxidative catalyst to be dispersed in the polymer matrix; and (3) an additive of an aldehyde that is to be dispersed in the polymer matrix, that is catalytically reactive with oxygen at room temperature in the presence of the oxidative catalyst, and that has a melting point greater than room temperature.

According to another aspect of this invention, there is provided a packaging article made from the melt-extruded polyester based blend.

### BRIEF DESCRIPTION OF THE DRAWING

Other features and advantages of the present invention will become apparent in the following detailed description of the preferred embodiments of this invention, with reference to the accompanying drawings, in which:

FIG. 1 is a thermo-gravimetric analysis plot illustrating the test results of oxygen scavenging capability of a polyester based blend of Example 2 of this invention according to an oxidative stability standard method; and

FIG. 2 is a thermo-gravimetric analysis plot illustrating the test results of oxygen scavenging capability of a polyester based blend of Example 2 and a commercially unmodified PET according to an oxidative induction time standard method.

### DETAILED DESCRIPTION OF THE PREFERRED EMBODIMENTS

A polyester based blend according to this invention includes a polyester, an oxidative catalyst, and an additive of an aldehyde that is catalytically reactive with oxygen at room temperature in the presence of the oxidative catalyst, and that has a melting point greater than room temperature. When the polyester based blend is melted and extruded, the polyester is formed into a polymer matrix for forming a packaging article, and the oxidation catalyst and the additive of the aldehyde are dispersed in the polymer matrix.

Preferably, the additive of the aldehyde is represented by the formula (I):

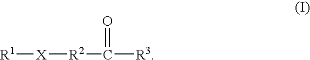

In formula (I), R¹ represents (1) an alkyl group, an alkenyl group, or an alkoxy group; (2) —CₙH₂ₙCOH, in which n is an integer ranging from 0 to 10; (3) —COR⁴, in which R⁴ represents an alkyl group, an alkenyl group, or an alkoxy group; or (4) —R⁵—COOH, in which R⁵ represents a single bond, an alkylene group, or an alkenylene group; X represents an arylene group, an alkylarylene group, or an alkylene group; R² represents a single bond, an alkylene group, or an alkenylene group; and R³ represents H, an alkyl group, an alkenyl group, or an alkoxy group, with the proviso that, when R³ is not a hydrogen atom, R¹ is (2) —CₙH₂ₙCOH.

More preferably, R¹ represents (1) a C₁˜C₁₀ alkyl group, a C₂˜C₁₀ alkenyl group, or a C₁˜C₁₀ alkoxy group; (2) —CₙH₂ₙCOH, in which n is an integer ranging from 0 to 10; (3) —COR⁴, in which R⁴ represents a C₁˜C₅ alkyl group, a C₂˜C₅ alkenyl group, or a C₁˜C₅ alkoxy group; or (4) —R⁵—COOH, in which R⁵ represents a single bond, a C₁˜C₅ alkylene group, or a C₂˜C₅ alkenylene group; X represents a C₆˜C₁₀ arylene group, a C₇˜C₁₂ alkylarylene group, or a C₁˜C₁₀ alkylene group; R² represents a single bond, a C₁˜C₄ alkylene group, or a C₂˜C₄ alkenylene group; and R³ represents H, a C₁˜C₁₀ alkyl group, a C₂˜C₁₀ alkenyl group, or a C₁˜C₁₀ alkoxy group.

Preferably, X represents an arylene group or an alkylarylene group. More preferably, X is selected from the group consisting of 1,4-phenylene, 1,3-phenylene, methylphenylene, dimethylphenylene and ethylphenylene.

Preferably, R¹ represents (1) a C₁˜C₅ alkyl group or a C₁˜C₅ alkoxy group, or (2) —CₙH₂ₙCOH, in which n is an integer ranging from 0 to 5.

Preferably, R² represents a single bond, methylene, ethylene or vinylene.

Preferably, R³ is H.

In some preferred embodiments of this invention, the aldehyde is terephthalic aldehyde, isophthalic aldehyde, 3-methyl formylbenzoate, 4-methyl formylbenzoate, or 4-methoxy cinnamaldehyde.

The polyester of the polyester based blend can be any polyester suitable for making a packaging article. Preferably, polyester is formed by condensation polymerization of a polyol and a polyacid selected from the group consisting of a diacid, an acid chloride derivative of the diacid, an ester derivative of the diacid and combinations thereof. More preferably, polyester is formed by condensation polymerization of a diol and a diacid.

Examples of the dial include ethylene glycol, 1,3-propylene glycol, naphthalene glycol, 1,2-propylene glycol, 1,2-cyclohexane dimethanol, 1,3-cyclohexane dimethanol, 1,4-cyclohexane dimethanol, diethylene glycol, hydroquinone, 1,3-butane dial, 1,5-pentane dial, 1,6-hexane dial, triethylene glycol, resorcinol, and combinations thereof. In a preferred embodiment of this invention, the dial is ethylene glycol.

Examples of the diacid include terephthalic acid, isophthalic acid, naphthalene-2,6-dicarboxylic acid, 2,3-dihydrobenzoic acid, 1,4-dihydronaphthoic acid, cyclohexane dicarboxylic acid, succinic acid, glutaric acid, adipic acid, sebacic acid, 1,12-dodecandioic acid, itaconic acid, and combinations thereof. In a preferred embodiment of this invention, the diacid is a mixture of terephthalic acid and isophthalic acid.

For making a packaging article with a superior mechanical property, preferably, the melting paint of the polyester ranges from 190° C. to 260° C., and more preferably, from 210° C. to 230° C.

Preferably, the molecular weight of the polyester ranges from 1000 to 60000 Dalton, more preferably, from 10000 to 50000 Dalton, and most preferably, from 15000 to 30000 Dalton.

The oxidative catalyst can be any catalyst suitable for oxidative reaction with the aldehyde. Preferably, the oxidative catalyst is a transitional metal oxidative catalyst. Examples of the transitional metal include, but are not limited to, Fe, Co, Ni, Ru, Rh, Pd, Os, Ir, Mo, Mn, Pt, etc. More preferably, the oxidative catalyst is cobalt acetate, cobalt neodecanoate, ferric chloride, cobaltous chloride, nickleous sulfate, cobaltous sulfate, manganese sulfate, molybdenyl acetylacetonate, molybdenum carbide, molybdenum hexacarbonyl, molybdenum trioxide, or combinations thereof.

The amount of the components in the polyester based blend can vary in accordance with actual requirements. The amount of the oxidative catalyst depends on that of the aldehyde. Preferably, based on 100 parts by weight of the polyester, the aldehyde is in an amount ranging from 0.01 to 20 parts by weight, more preferably, from 0.5 to 15 parts by weight, and most preferably, from 1 to 10 parts by weight.

Preferably, based on 100 parts by weight of the aldehyde, the oxidative catalyst is in an amount ranging from 0.005 to 1 part by weight, more preferably, from 0.075 to 0.5 part by weight, and most preferably, from 0.01 to 0.1 part by weight.

The polyester based blend of this invention is prepared by mixing the polyester, the oxidative catalyst, and the aldehyde so as to form a mixture, followed by extruding the mixture to obtain the polyester based blend. The mixing step can be conducted by any mixing method known in the art, preferably, by a melt-blending method. The polyester based blend may be in the form of granules for storing, or directly made into a portion of the packaging article or the packaging article through steps, e.g. melt-extrusion, extrusion blow molding, film casting, sheet extrusion, injection molding, etc. The packaging article can be, but is not limited to, a sealed bag, a beverage bottle (e.g., a juice bottle, a beer bottle), a film, a sealed box, etc. Preferably, the packaging article is a bottle.

Since the aldehyde reacts with oxygen in the presence of the oxidative catalyst under room temperature, before preparing the polyester based blend, it is preferable that the oxidative catalyst of the polyester based blend and the additive of aldehyde of the polyester based blend be kept separate from each other. For example, the polyester based blend of this invention is comprised of a first premix containing a part of the polyester and the oxidative catalyst and a second premix containing the remainder of the polyester and the additive of aldehyde. The first and second premixes are kept separate during storage. In preparing the packaging article, the weight ratio of the first premix to the second premix can be varied based on actual requirements.

The polyester based blend of this invention is suitable for making a packaging article with high transparency and high mechanical property that can meet the industries' needs for packaging purposes. In addition, the packaging article made from the polyester based blend exhibits an oxygen scavenging capability under room temperature, and thus prevents oxygen in ambient air from permeating through the packaging article. The oxygen scavenging effectiveness and the life time of the oxygen scavenging of the packaging article can be controlled by adjusting the amount of the aldehyde in the polyester based blend.

The following examples and comparative examples are provided to illustrate the merits of the preferred embodiments of the invention, and should not be construed as limiting the scope of the invention.

### EXAMPLE

### Example 1

20 kg of PET granules (trade name: CB607, purchased from Far Eastern Textile Ltd.), 2 kg of terephthalic aldehyde, and 1.2 g of cobalt acetate (the content of the cobalt in the cobalt acetate was 24.9 wt %) were blended and then introduced into a Co-rotating twin-screw extruder (model No. PSM50, purchased from Sino-Alloy Machine, Inc., L/D of the screw is 36). Nitrogen was introduced into a feed port of the extruder (the flow rate of the nitrogen was 60 mL/min). The rotating speed of the screw was 180 rpm, and the temperature in a divisional heating zone was controlled at 160˜240° C. The mixture was melted and extruded, and then granulated to generate polyester based blend granules (the weight ratio of terephthalic aldehyde to PET was 10 to 100).

### Example 2

Polyethylene terephthalate (PET) was prepared by a conventional method, i.e., terephthalic acid and isophthalic acid were mixed at a weight ratio of 9:1 so as to obtain a diacid mixture, and the diacid mixture was reacted with ethylene glycol at a weight ratio of 1:1.25 by virtue of esterification condensation, followed by granulation so as to obtain PET granules. The final temperature of the condensation reaction was 285° C. A Differential Scanning Calorimeter (DSC, model No. DSC module 2910, purchased from American TA Instrument Co.), was used to measure the melting point of the PET granules. The melting point of the PET granules was 223° C.

For preparing a first premix, the PET granules thus formed and the terephthalic aldehyde were introduced into a Co-rotating twin-screw extruder at a feeding rate of 40 Kg/hr and 2 kg/hr, respectively, to conduct melting extrusion so as to obtain the first premix. Nitrogen was introduced into a feed port of a screw of the extruder at a flow rate of 60 mL/min. The rotating speed of the screw was 180 rpm, and the temperature in a divisional heating zone was controlled at 160˜240° C.

For preparing a second premix, terephthalic acid and isophthalic acid were mixed at a weight ratio of 9:1 so as to obtain a diacid mixture, and the diacid mixture was reacted with ethylene glycol at a weight ratio of 1:1.25 by virtue of esterification condensation, followed by granulation so as to obtain PET granules. During the esterification condensation reaction, 5000 ppm of cobalt acetate was added into the reaction. The final temperature of the condensation reaction was 285° C.

The first premix and the second premix at the weight ratio of 9:1 were melt-extruded in a Co-rotating twin-screw extruder so as to obtain a polyester based blend the weight ratio of terephthalic aldehyde to PET was 3 to 100). Nitrogen was introduced into a feed port of a screw of the extruder at a flow rate of 60 mL/min, the rotating speed of the screw was 200 rpm, and the temperature in the divisional heating zone was controlled at 160˜210° C.

### Example 3

The procedure and conditions in preparing the polyester based blend of Example 3 were similar to those of Example 2, except that in Example 3, isophthalic aldehyde was used to replace terephthalic aldehyde and that the weight ratio of isophthalic aldehyde to PET was 3 to 100.

### Example 4

The procedure and conditions in preparing the polyester based blend of Example 4 were similar to those of Example 2, except that in Example 4,4-methoxy cinnamaldehyde was used to replace terephthalic aldehyde and that the weight ratio of 4-methoxy cinnamaldehyde to PET was 3 to 100.

### Example 5

The procedure and conditions in preparing the polyester based blend of Example 5 were similar to those of Example 2, except that in Example 5, 4-methyl formylbenzoate was used to replace terephthalic aldehyde and that the weight ratio of 4-methyl formylbenzoate to PET was 3 to 100.

### Property Tests for Polyester Based Blend of Example 1-5

### Test 1

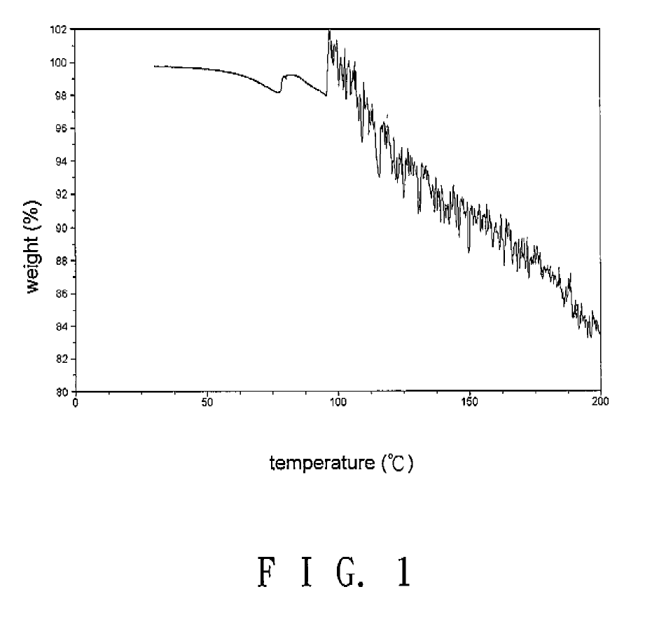

According to the oxidative stability standard method ASTM D169, 40 mg of the polyester based blend of Example 2 was tested and heated in a thermo-gravimetric analyzer (TGA, model No. TGA2950, purchased from TA Instrument Co., U.S.A.) under a gaseous mixture that contained nitrogen and dry air and that had a flow rate of 100 mL/min. The operating temperature of the heating process in the above test was started at 30° C., then raised to 80° C. at a raising rate of 2° C./min, and was kept at 80° C. for 120 min. Variations of the weight of the polyester based blend of Example 2 with respect to the operating temperature were recorded, and the results thus obtained are shown in FIG. 1.

As shown in FIG. 1, the percentage by weight of the polyester based blend rapidly increased from 100% to 102% when the operating temperature reached about 90° C. The abrupt increase of the percentage by weight of the polyester based blend is attributed to the reaction of permeated oxygen from the dry air with the aldehyde of the polyester based blend into an acid, which demonstrates that the polyester based blend of this invention exhibits an oxygen scavenging capability.

### Test 2

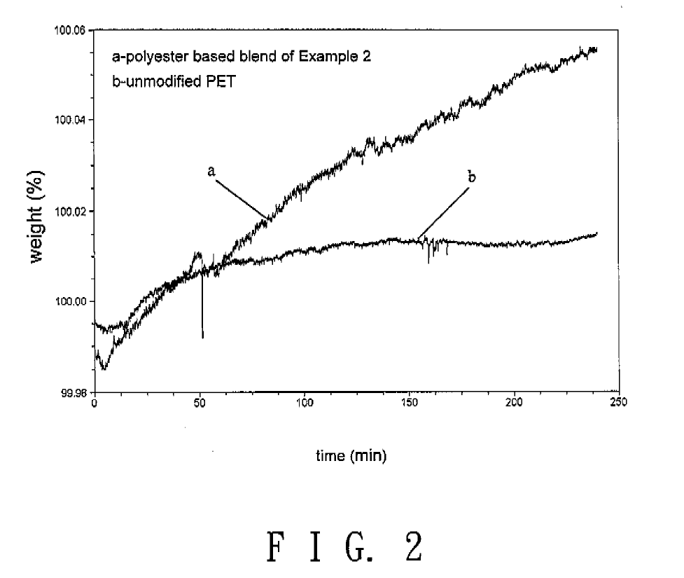

According to the oxidative induction time standard method ASTM D3895, 40 mg of the polyester based blend of Example 2 was tested in a thermo-gravimetric analyzer under a gaseous mixture that contained nitrogen and dry air and that had a flow rate of 100 mL/min at room temperature. In similar conditions, the same amount of a commercial unmodified PET (trade name: CB607, purchased from Far Eastern Textile Ltd.) was tested. The test results are shown in FIG. 2.

As shown in FIG. 2, the percentage by weight of the polyester based blend of Example 2 continued to increase starting from at about the 50-minute mark to the end time of the test (the total time of the test was about 240 minutes), while the percentage by weight of the commercially unmodified PET substantially remained the same during this period, which demonstrates that the polyester based blend of this invention exhibits an oxygen scavenging capability.

### Test 3

10 g of each of the polyester based blends of Examples 2˜5 and the commercially unmodified PET were respectively placed in a sealed sampling vessel of a trace oxygen monitoring system (model No. MC-8G, purchased from Iijima Electronics Co., Japan). The sampling vessel was filled with oxygen having a concentration of 20.9%, the temperature of the sampling vessel was 26° C., and the relative humidity of the sampling vessel was 60% RH. The oxygen concentration in the sampling vessel was recorded for a period of 120 days. The results are shown in Table 1. The oxygen concentration test results can be used to evaluate the oxygen scavenging effect of the test sample, i.e., the lower the oxygen concentration in the sampling vessel, the higher the oxygen scavenging effect will be for the test sample.

TABLE 1

| | Oxygen Concentration | | | | |
|---|---|---|---|---|---|
| | Commercially | | | | |
| Day | unmodified PET | Example 2 | Example 3 | Example 4 | Example 5 |
| 0 | 20.9% | 20.9% | 20.9% | 20.9% | 20.9% |
| 5 | 20.9% | — | 20.3% | 20.5% | 20.5% |
| 10 | 20.5% | 18.6% | 18.9% | 19.6% | 19.3% |
| 22 | 20.3% | 16.9% | — | — | — |
| 30 | 20.3% | — | 16.8% | 18.8% | 18.5% |
| 32 | 20.3% | 15.5% | — | — | — |
| 42 | 20.3% | 13.6% | — | — | — |
| 52 | 20.3% | 12.1% | — | — | — |
| 60 | 20.3% | — | 11.1% | 17.1% | 15.0% |
| 62 | 20.3% | 10.1% | — | — | — |
| 82 | 20.3% | 9.9% | — | — | — |
| 90 | 20.3% | — | 10.2% | 16.3% | 14.0% |
| 92 | 20.3% | 9.2% | — | — | — |
| 102 | 20.3% | 8.7% | — | — | — |
| 112 | 20.3% | 7.5% | — | — | — |
| 120 | 20.3% | 6.39% | 7.5% | 15.0% | 11.9% |

—: measurement not taken

As shown in Table 1, after 120 days, the oxygen concentration in the sampling vessel for the commercially unmodified PET substantially remained the same, while the oxygen concentration for Example 2 decreased from 20.9% to 6.39%, i.e., 69% of oxygen consumption. This result demonstrates that the polyester based blend of Example 2 exhibits an oxygen scavenging capability for 120 days or above. Similar results were achieved for Examples 3˜5.

### Test 4

The polyester based blends of each of Examples 1˜5 was molded into a bottle preform using a bottle preform injection molding machine (model No. Hypet90, purchased from Husky Co.) in a conventional manner. The bottle preform was then formed into a bottle using a blow molding machine (purchased from Chia-Ming Machinery Co., Ltd.) in a conventional manner.

The above test reveals that the polyester based blend of this invention can be made into a bottle in a conventional manner.

### Test 5

The bottle made from the polyester based blend of Example 2 in Test 4 was subjected to a haze test using a Haze Meter (model No. IDH-2000, purchased from Nippon Denshoku Co.). The commercially unmodified PET was also subjected to this test. The test results are shown in Table 2. It is noted that the bottle is rated as having a good transparency when the haze value thereof is lower than 5%.

TABLE 2

| | | Haze value | Transmittance |
|---|---|---|---|
| Commercially unmodified PET | | 1.55% | 85.31% |
| Example 2 | 1 day | 2.21% | 85.53% |
| | 120 days | 3.29% | 85.29% |

As shown in Table 2, the bottle made from the polyester based blend of Example 2 has an initial haze value of lower than 5% and an acceptable transmittance. After 120 days, the haze value of the bottle made from the polyester based blend of Example 2 is only slightly increased.

In conclusion, the polyester based blend of this invention has an excellent oxygen scavenging capability. The packaging article made from the polyester based blend of this invention also has a good transparency.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A polyester based blend capable of scavenging oxygen and useful for making a packaging article, comprising:
a polyester to be formed into a polymer matrix for the packaging article when said polyester based blend is melted and extruded;
an oxidative catalyst to be dispersed in the polymer matrix; and
an additive of an aldehyde that is to be dispersed in the polymer matrix, that is catalytically reactive with oxygen at room temperature in the presence of said oxidative catalyst, and that has a melting point greater than room temperature.

2. The polyester based blend of claim 1, wherein said aldehyde is represented by the formula (I): 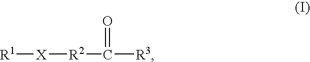
wherein R¹ represents (1) an alkyl group, an alkenyl group, or an alkoxy group; (2) —CₙH₂ₙCOH, in which n is an integer ranging from 0 to 10; (3) —COR⁴, in which R⁴ represents an alkyl group, an alkenyl group, or an alkoxy group; or (4) —R⁵—COOH, in which R⁵ represents a single bond, an alkylene group, or an alkenylene group;
X represents an arylene group, an alkylarylene group, or an alkylene group;
R² represents a single bond, an alkylene group, or an alkenylene group; and
R³ represents H, an alkyl group, an alkenyl group, or an alkoxy group, with the proviso that, when R³ is not a hydrogen atom, R¹ is (2) —CₙH₂ₙCOH.

3. The polyester based blend of claim 2, wherein R¹ represents (1) a C₁˜C₁₀ alkyl group, a C₂˜C₁₀ alkenyl group, or a C₁˜C₁₀ alkoxy group; (2) —CₙH₂ₙCOH, in which n is an integer ranging from 0 to 10; (3) —COR⁴, in which R⁴ represents a C₁˜C₅ alkyl group, a C₂˜C₅ alkenyl group, or a C₁˜C₅ alkoxy group; or (4) —R⁵—COCH, in which R⁵ represents a single bond, a C₁˜C₅ alkylene group, or a C₂˜C₅ alkenylene group;
X represents a C₆˜C₁₀ arylene group, a C₇˜C₁₂ alkylarylene group, or a C₁˜C₁₀ alkylene group;
R² represents a single bond, a C₁˜C₄ alkylene group, or a C₂˜C₄ alkenylene group; and
R³ represents H, a C₁˜C₁₀ alkyl group, a C₂˜C₁₀ alkenyl group, or a C₁˜C₁₀ alkoxy group, with the proviso that, when R³ is not H, R¹ is (2) —CₙH₂ₙ—COH.

4. The polyester based blend of claim 3, wherein X represents an arylene group or an alkylarylene group.

5. The polyester based blend of claim 4, wherein X is selected from the group consisting of 1,4-phenylene, 1,3-phenylene, methylphenylene, dimethylphenylene and ethylphenylene.

6. The polyester based blend of claim 3, wherein R¹ represents (1) a C₁˜C₅ alkyl group or a C₁˜C₅ alkoxy group, or (2) —CₙH₂ₙCOH, in which n is an integer ranging from 0 to 5.

7. The polyester based blend of claim 3, wherein R² represents a single bond, methylene, ethylene or vinylene.

8. The polyester based blend of claim 3, wherein R³ is H.

9. The polyester based blend of claim 1, wherein the melting point of said polyester ranges from 190° C. to 260° C.

10. The polyester based blend of claim 9, wherein said polyester is formed by condensation polymerization of a diol and a diacid.

11. The polyester based blend of claim 10, wherein said diacid is selected from the group consisting of terephthalic acid, isophthalic acid, naphthalene-2,6-dicarboxylic acid, 2,3-dihydrobenzoic acid, 1,4-dihydrobenzoic acid, cyclohexane dicarboxylic acid, succinic acid, glutaric acid, adipic acid, sebacic acid, 1,12-dodecandioic acid, itaconic acid, and combinations thereof.

12. The polyester based blend of claim 10, wherein said diol is selected from the group consisting of ethylene glycol, 1,3-propylene glycol, naphthalene glycol, 1,2-propylene glycol, 1,2-cyclohexane dimethanol, 1,3-cyclohexane dimethanol, 1,4-cyclohexane dimethanol, diethylene glycol, hydroquinone, 1,3-butane diol, 1,5-pentane diol, 1,6-hexane diol, triethylene glycol, resorcinol and combinations thereof.

13. The polyester based blend of claim 1, wherein said oxidative catalyst is a transitional metal oxidative catalyst.

14. The polyester based blend of claim 1, wherein said aldehyde is in an amount ranging from 0.01 to 20 parts by weight per 100 parts by weight of said polyester.

15. The polyester based blend of claim 1, wherein said oxidative catalyst is in an amount ranging from 0.005 to 1 part by weight per 100 parts by weight of said aldehyde.

16. A packaging article made from a melt-extruded polyester based blend of claim 1.

17. The packaging article of claim 16, wherein said packaging article is a bottle.
